(19) United States
(12) Patent Application Publication
(10) Pub. No.: US 2008/0293432 A1
(43) Pub. Date: Nov. 27, 2008

(54) Location information to identify known location for internet phone

(75) Inventors: William Kam Stewart, San Francisco, CA (US); Craig C. Hamilton, Sunnyvale, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/807,058

(22) Filed: May 25, 2007

(51) Int. Cl. H04Q 7/20

(52) U.S. Cl. 455/456.1

(57) ABSTRACT

A mobile phone includes the ability to place calls using a voice over Internet protocol. Location information is provided from the phone itself which can be used to identify the location of the mobile phone.

### BACKGROUND

In emergency situations, callers may delay in providing information relating to their location. In response, a system for identifying the house from which a call was being placed has been developed. For VoIP based calling systems in homes, the VoIP provider identifies a user and records the user's physical address. When an emergency call is made using the VoIP phone, the VoIP service provider assumes that the call is being made from the physical address that corresponds to the identity of the user making the call. However, these locations are tied to a single address.

This system is not entirely effective for identifying the location from which a call was placed in emergency situations with VoIP mobile phones that can roam because these phones are not tied to a single address or location.

### BRIEF DESCRIPTION OF THE DRAWINGS

FIG. 1 is a schematic diagram showing components of a system including a mobile device according to some embodiments;

FIG. 2 is a schematic diagram of a set of applications for a mobile device according to some embodiments;

FIG. 3 is a flow diagram for providing location information according to some embodiments;

FIG. 4 is a flow diagram of providing location information in response to a phone call according to some embodiments;

FIG. 5 is a flow diagram of providing location information in response to a phone call according to some embodiments;

FIGS. 6A-E are a series of screen shots of a phone dialing screen according to some embodiments; and

FIGS. 7A-F are illustrations of a mobile device according to some embodiments.

### DETAILED DESCRIPTION OF EXEMPLARY EMBODIMENTS

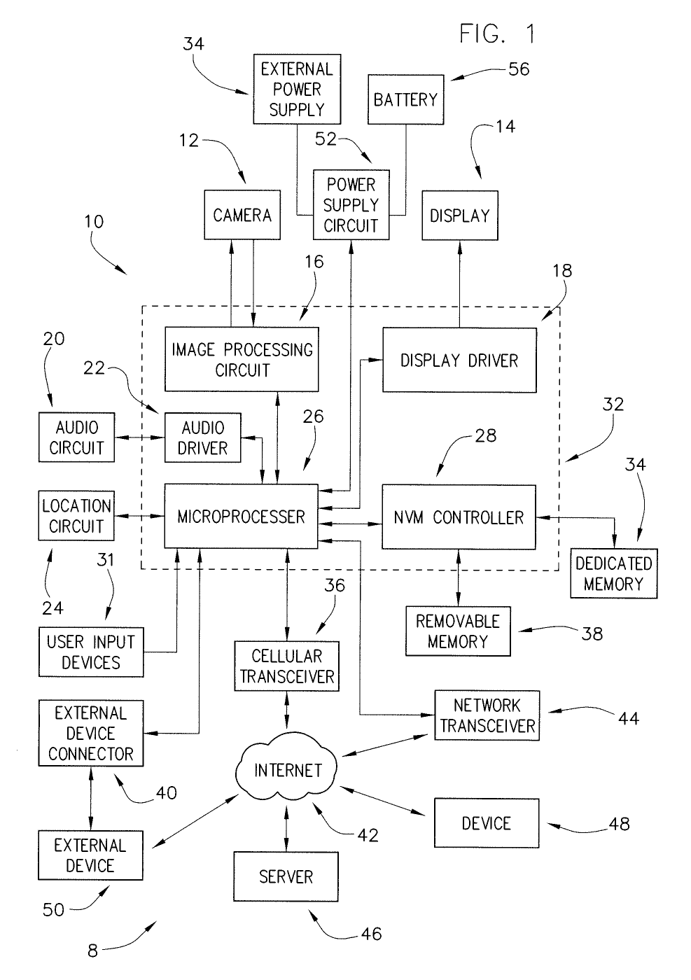

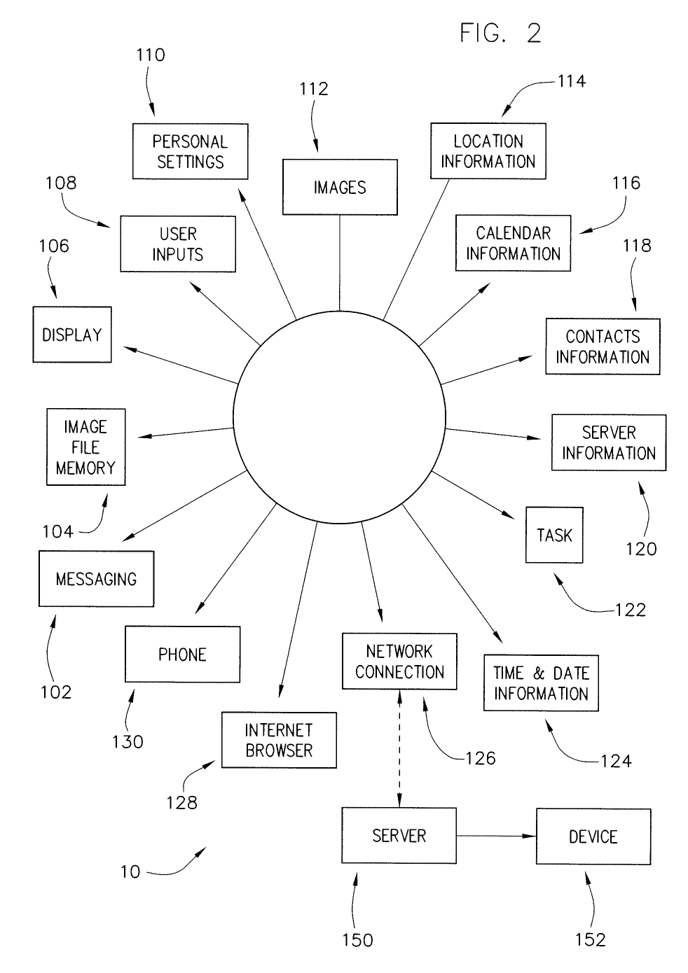

Referring to FIG. 1, a system 8 includes portable electronic device 10 capable of enabling voice communication with other devices (e.g. phones). Device 10 generally includes a processing circuit 32 configured to run a phone application 130 (FIG. 2) which can be configured to allow device 10 to provide voice communication using a Voice over Internet Protocol (VoIP).

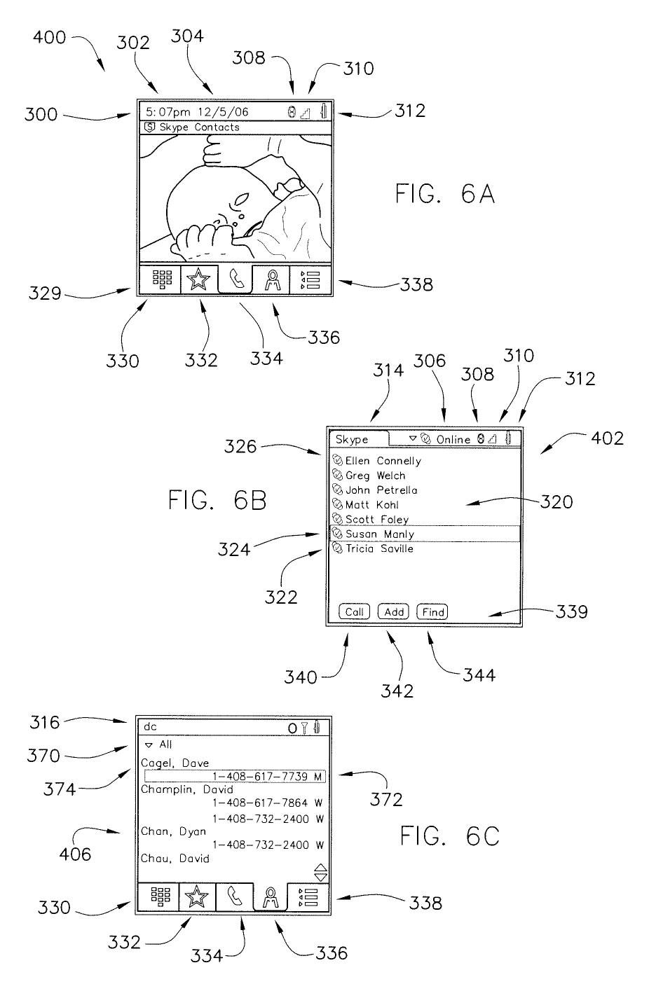

Device 10 includes an audio circuit 20 configured to receive audio information from a user (e.g. from a microphone 625—FIG. 5). Processing circuit 32 may be configured to process the information from audio circuit 20 and configure the audio information in a format capable of being transmitted to another device. For example, processing circuit 32 may be configured to convert the audio information from audio circuit 20 to a network format (e.g. VoIP format) for transmission across a network (e.g. a Wide Area Network (WAN) such as the Internet). In many embodiments, the network format may be a data format such that audio conversation can be transferred over a data network and/or a data portion of a network having both voice and data portions.

Device 10 may be configured such that it can roam using the network format (e.g. VoIP format) for voice communication (i.e. device 10 may be configured such that it can place VoIP calls by interfacing with various access points and/or networks in different geographical regions). Device 10 may further be configured such that it can maintain voice communication even though it might be moving out of range of one access point within a region and into range of another access point within that region.

Device 10 also includes an audio circuit 20 configured to provide audio information to a user (e.g. speaker 602,616—FIG. 5). The audio information provided by audio circuit 20 is based on audio data provided by processing circuit 32. For example, processing circuit 32 may be configured to receive voice data from a network in a network transmission format (e.g. a WAN format such as a VoIP format). Processing circuit 32 may be configured to process the formatted voice data in order to provide a voice data signal to audio circuit 20 (e.g. microprocessor 26 may be configured to receive voice data in the network format and then provide a data signal to audio driver circuit 22 in order to produce sound in one or more speakers of audio circuit 20).

Voice data (e.g. voice data in the network format) provided and/or received by processing circuit 32 may be transferred to other devices using a transceiver, such as a cellular transceiver 36 and/or a network transceiver 44. In some embodiments, phone application 130 having a VoIP mode solely uses a network transceiver for VoIP voice data transfers (i.e. phone application 130 does not transfer voice data in the VoIP mode using cellular transceiver 36).

In some embodiments, device 10 includes both a network transceiver 44 and a cellular transceiver 36. In some embodiments, device 10 does not include a cellular transceiver 36. Device 10 may use any combination of transceivers (including multiples of a type of transceiver), and all such combinations are contemplated.

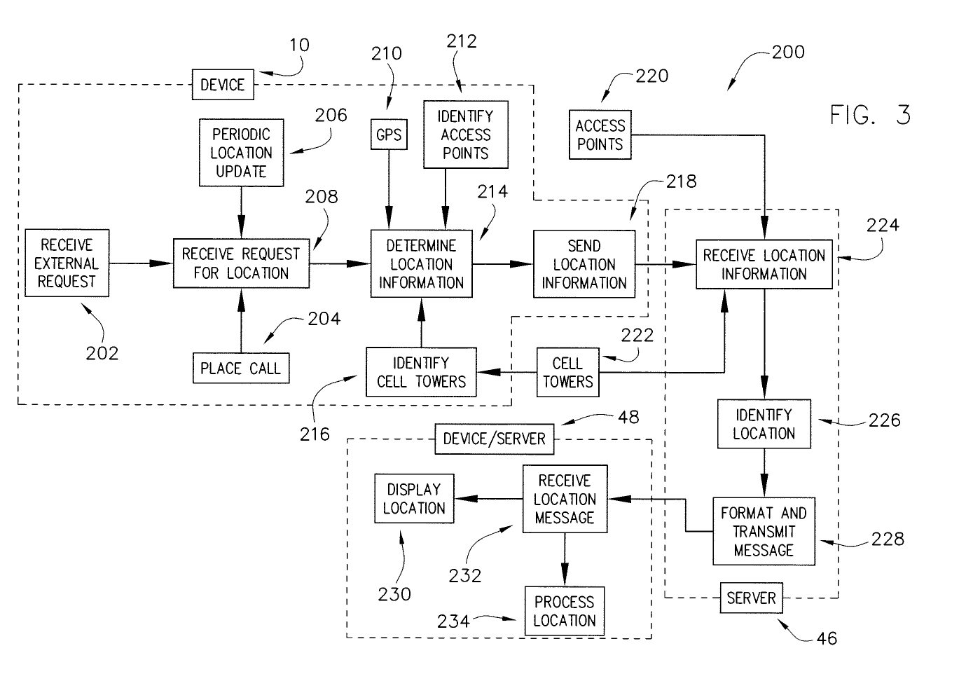

Device 10 may also include a location circuit 24 (e.g. GPS circuit) configured to provide information relating to a location of device 10. Device 10 may be configured to provide location information representative of a location of device 10 during a phone call made while phone application 130 is in a VoIP mode. As discussed with respect to FIG. 3, location circuit 24 may be configured to provide the location information.

Referring to FIG. 3, device 10 may be configured to provide location information representative of the location of device 10 to another device/server 48. The information provided from device 10 may be transferred to an intermediate device (e.g. server 46) before being transferred to the device/server 48.

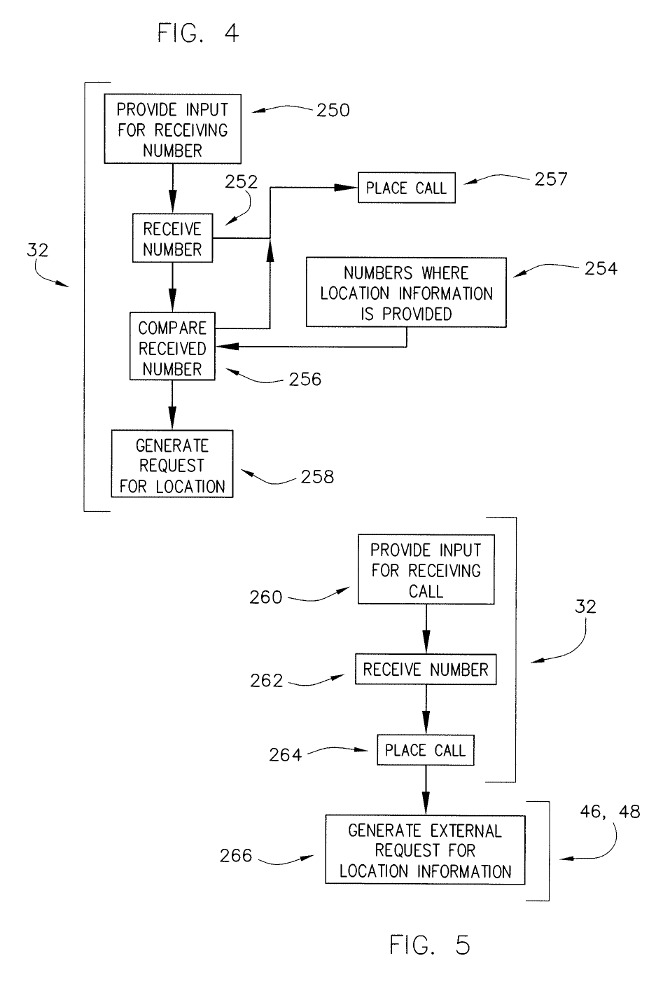

Device 10 may receive a request for location information at block 208. The request for information may be based on a call placed using phone application 130 (FIG. 2) at block 204. As one example, referring to FIG. 4, processing circuit 32 may be configured to provide location information when particular numbers are dialed. Processing circuit 32 may be configured to provide one or more user inputs to enter a number at block 250. Examples of user inputs include a box in which a user can enter information, a contact list which a user can scroll to choose a number, a voice recognition function that allows a user to speak a number, a name of a contact, or other information to dial a number, etc. A number entered by a user at block 250 may be received by processing circuit 32 at block 252. At block 256, processing circuit 32 may compare the number received at block 252 with a list of numbers that, in response to that number being selected, processing circuit 32 provides location information. The list of numbers may be stored by device 10, may be accessed by device 10 from a remote device, may be pre-programmed, may be entirely user definable, may include a list of numbers provided by a user, may be periodically updated, may be stored in any location, may be accessed in any manner, and/or may have any other configuration. The numbers for which location information is generated may include emergency services numbers such as 911.

If there is a match between the number received at block 252 and the list of numbers stored at block 254, then processing circuit 32 may generate a request for location information at block 258. Processing circuit 32 may also be configured to place the call at block 257 based on the number received at block 252. The call may be placed using a network protocol (e.g. a WAN protocol such as VoIP). In some embodiments, processing circuit 32 will place a call as a cellular call based on the comparison at block 258 (e.g. if the number being dialed is an emergency number) even if the phone application 130 is in a different mode (e.g. VoIP mode). In some embodiments, processing circuit 32 will determine which voice transfer mode (e.g. cellular mode, VoIP mode, etc.) offers the strongest signal and will place the call using the mode corresponding to the strongest signal based on the comparison at block 258 (e.g. if the comparison shows that the call is to an emergency service). As another example of block 204, referring back to FIG. 3, device 10 may provide location information for each call placed by device 10, each call placed to a contact stored in a contacts application 118 (FIG. 2), each call placed using a particular phone application 130 (FIG. 2), each call placed while device is in a particular calling mode (e.g. a VoIP mode), etc.

The request for information received at block 208 may be based on an external request for information at block 202. As an example, referring to FIG. 5, processing circuit 32 may provide an input at block 260, receive a number at block 262, and place a call at block 264 as discussed above. In response to receiving the call, a remote device (e.g. a device of an emergency service) may generate a request for location information at block 266. In this example, the request is generated in response to a call placed by device 10. As another example of block 202, external requests may be received based on other actions, such as a request for location received from a device belonging to a buddy of the user of device 10, a request for location received from a server that tracks the location of device 10, a request for location information received from a location-based search (LBS) engine, etc.

The request for information at block 208 may be based on a periodic request to update location information at block 206 (e.g. to send to a remote server or device, a location tracking service, etc.).

Once the request for location information is received at block 208, device 10 may be configured to determine location information (e.g. gather information useful for determining a location of device 10, calculate a location of device 10 which may be coordinates, address, and/or may take some other form, sort through sources of location information, etc.). The location information may be determined based on data from multiple sources. The sources may include internal sources (sources contained within device 10) such as a GPS circuit 210 or other location circuit 24 (FIG. 1). The sources may include proximate sources (sources proximate device 10 including local internal sources and local external sources) such as a GPS device communicating with device 10 using a Bluetooth connection. The sources may include remote sources (sources located a distance from device 10), which may include wireless data network components (e.g. an identity of a network access point or points 220 used by a network transceiver 44 to transfer data to a network, an identity of cell towers 222 used by a cellular transceiver 36 to transfer data over a cellular network, etc.), remote databases containing information used by the device 10 to determine location, etc. The remote sources may transmit this information to device 10 in response to the request for location information at block 208 and/or device 10 may be continuously monitoring this information.

The location information determined at block 214 may be sent to a remote server 46 or device/server 48 at block 218. The information transmitted at block 218 may include the location of device 10, and/or information that is usable to determine the location of device 10. The information may be sent using any transmitter of device 10 such as cellular transceiver 36 and network transceiver 44. The information transmitted is received by server 46 at block 224. Server 46 may also receive information from other sources such as information from a system that relates an identity of a wireless data system point(s) (e.g. network access point 220, cell towers 222, etc.) accessed and/or accessible by device 10 to a physical location.

In some embodiments of device 10 that include a cellular transceiver, when device 10 places a call in VoIP mode where location information is desired (e.g. an emergency call), device 10 is configured to place a cellular call to aid in determining the location of device 10 based on the cell towers that received the call.

Based on the location information received at block 224, a location of device 10 is identified at block 226. Identifying the location may include eliminating some location information as unreliable, determining confidence in the location by comparing locations calculated by different methods and/or using different information, may include using some information to get a rough estimate of location and other information to refine the rough calculation, and/or other steps and procedures.

Identifying a location of device 10 based on information relating to an access point 220 accessed or accessible by device 10 may include storing a list of physical locations of various access points (which may be identified based on their IP address). The address of the access point that was accessed by or accessible to device 10 (which may be provided to server 48 by device 10 or by some other source) can be looked up using the list. The location of device 10 can be determined using one or more of the addresses looked up from the list. The list can be updated if the access point is moved. If the list is contained in device 10, the device 10 may only contain a partial list of access points which is updated based on the location of device 10 and/or based on the access points used by device 10.

Information relating to the location of device 10 identified at block 226 is formatted in a format that is readable by device/server 48 and then transmitted to device/server 48 at block 228. According to some embodiments, the functions at blocks 224-228 are performed by device 10.

The transmitted location information from block 228 is received by the device/server 48 at block 232. In some embodiments, device/server 48 is an emergency services computer or console. Device/server 48 may be configured to display information relating to the location of device 10 at block 230. Device/server 48 may be configured to perform other processing on the location information, such as providing the location information to other devices (e.g. emergency vehicles dispatched to address the emergency situation), create a record of the location (such as a record of an emergency call including the location from which the call was placed), and/or other processing.

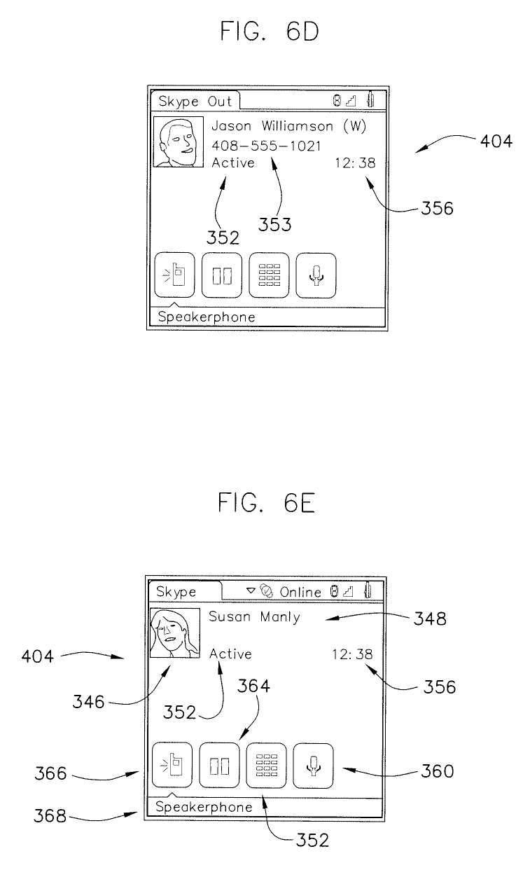

Referring to FIG. 6A, a VoIP main screen 400 includes a plurality of system data 300 and screen options 329. System data 300 can include time information 302, date information 304, a wireless system status indicator 308, 310, and a battery indicator 312. System data 300 can also include a device status bar 306 (FIG. 6B) that reflects the status of the device on a network. Device status bar 306 may be user editable such that a user may select the status of device 10 shown on the network. For example, device status indicator 306 can be used to show the availability of device 10. The status of device 10 may affect whether others can contact device 10, such as over a VoIP network. Examples of status indicators that may be used include “on-line,” “do not disturb,” “silent,” “off-line,” “in a meeting,” etc. Each status may provide defined settings (ringer volume, availability to receive calls, status shown to external devices/other users, etc.) or a selectable status may provide user configurable settings.

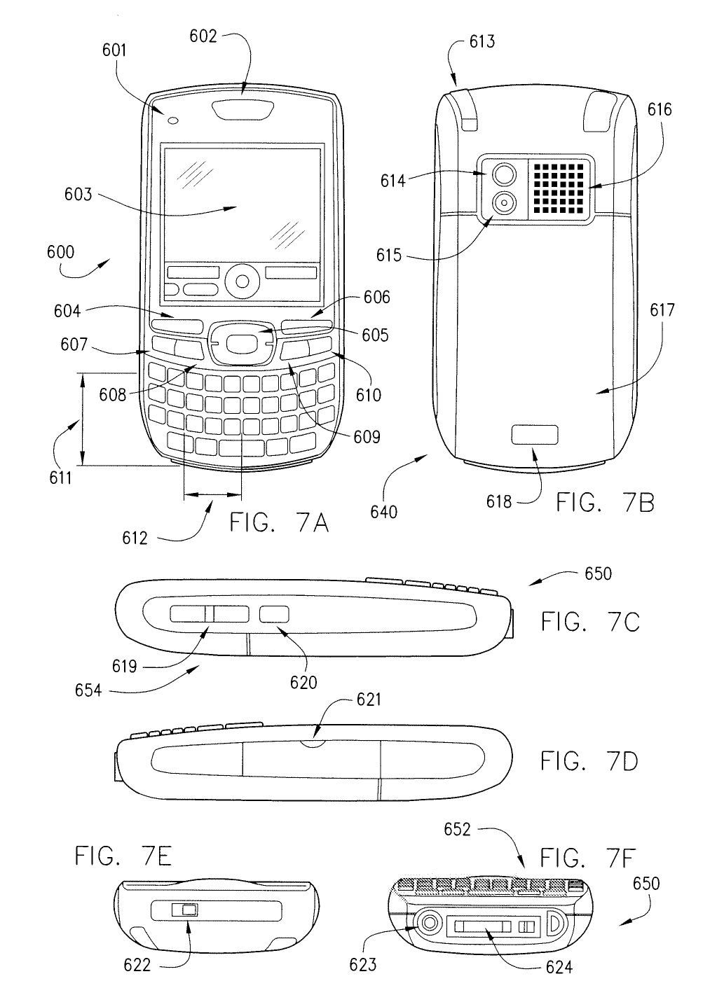

Screen options 329 can be used to provide control for various functionality of a VoIP application. A number pad screen option 330 can allow a user to pull up a number pad on screen 400 (or a different screen) so that a user can enter a number using a touch screen display 14 (FIG. 1) or other reconfigurable user inputs (e.g. controlling screen options using a navigator 605 (FIG. 7A). Another screen option 329 is a favorites screen option 332 that allows a user to access a favorites screen 402 (FIG. 6B). Another screen option 336 is a contacts screen option 336 that is used to access a contacts screen 406 (FIG. 6C). Screen options 336 may include a call log screen option 338 that allows a user to access a call log.

Referring to FIG. 6B, a favorites screen 402 may include a list of commonly dialed numbers (e.g. speed dials). Status indicators 326 may be used to indicate the status of contacts 320 who have been added to the favorites screen 402. For example, an icon 322 may be used to show that a user is available (e.g. on-line) and another icon 324 can be used to show that a user's status is unknown or unavailable. Screen 402 may also include other control options 339 such as an option 340 to call a selected contact, an option 342 to add a contact to the list (e.g. based on a recent call, from a user's stored contacts, from a global directory, etc.), an option 344 to find other contacts (e.g. from a user's stored contacts, from a global directory such as a service provider's directory, a phone book application, a user's work directory, etc.) The favorites screen 402 could also include a call log of recently dialed and/or received phone numbers, or other numbers or information that a user may wish to access quickly.

If a user's contacts are accessed using option 336, display 14 may display a contacts screen 406. Contacts screen 406 may include a list of contacts 374 including contact numbers 372 for the user. The contact numbers may include traditional phone numbers 372 usable to call a contact on a phone line (e.g. a land line or cell phone line), or may include numbers primarily usable to contact a user using a VoIP line. Contacts screen 406 may be a contacts application within the VoIP application or could be a primary contacts application (e.g. usable to make voice calls as well). Device 10 may dial a number by selecting the number from the contacts screen 406. Device 10 may automatically place the call using VoIP (e.g. based on if the contacts screen 406 is accessed from a VoIP application, based on if VoIP access is available and cellular service is not, based on user settings such as to place all calls using VoIP if VoIP is available, such as a user setting for a particular number, based on the number being in a form for use primarily in VoIP, etc.) or may provide the user with an option of how to place a call.

Referring to FIGS. 6D and 6E, when a call is placed, a call screen 404 may be used. The call screen may display information relating to the call such as the status 352 of the call, the duration 356 of the call, the number 353 called, a textual identification 348 of the person being called, a picture 346 of the person being called, etc. The call screen 404 may also provide the user with various controls. For example, the call screen 404 may include an option 366 to switch between a speakerphone mode and a handset mode, an option 364 to put the call on hold, an option 362 to access a number pad, a mute option 360 such as to mute the microphone of device 10, etc.

### Other Features

Referring back to FIG. 1, portable device 10 may be a mobile computing device capable of executing software programs. The device 10 may be implemented as a combination handheld computer and mobile telephone, sometimes referred to as a smart phone. Examples of smart phones include, for example, Palm® products such as Palm® Treo™ smart phones. Although some embodiments may be described with portable device 10 implemented as a smart phone by way of example, it may be appreciated that the embodiments are not limited in this context. For example, portable device 10 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, camera, pager, messaging device, data communication device, and so forth.

Processing circuit 32 of hand-held device 10 may include one or more of a microprocessor 26, image processing circuit 16, display driver 18, NVM controller 28, audio driver 22 (e.g. D/A converter, A/D converter, an audio coder and/or decoder (codec), amplifier, etc.), and other processing circuits. Processing circuit 32 can include various types of processing circuitry, digital and/or analog, and may include one or more of a microprocessor, microcontroller, application-specific integrated circuit (ASIC), field programmable gate array (FPGA), or other circuitry configured to perform various input/output, control, analysis, and other functions. In various embodiments, the processing circuit 32 may include a central processing unit (CPU) using any suitable processor or logic device, such as a as a general purpose processor. Processing circuit 32 may include, or be implemented as, a chip multiprocessor (CMP), dedicated processor, embedded processor, media processor, input/output (I/O) processor, co-processor, a microprocessor such as a complex instruction set computer (CISC) microprocessor, a reduced instruction set computing (RISC) microprocessor, and/or a very long instruction word (VLIW) microprocessor, a processor implementing a combination of instruction sets, a controller, a microcontroller, an application specific integrated circuit (ASIC), a field programmable gate array (FPGA), a programmable logic device (PLD), or other processing device in accordance with the described embodiments.

Processing circuit 32 may be configured to digitize data, to filter data, to analyze data, to combine data, to output command signals, and/or to process data in some other manner. Processing circuit 32 may be configured to perform digital-to-analog conversion (DAC), analog-to-digital conversion (ADC), modulation, demodulation, encoding, decoding, encryption, decryption, etc. Processing circuit 32 (e.g. microprocessor 26) may be configured to execute various software programs such as application programs and system programs to provide computing and processing operations for device 10.

Processing circuit 32 may also include a memory that stores data. Processing circuit may include only one of a type of component (e.g. one microprocessor), or may contain multiple components of that type (e.g. multiple microprocessors). Processing circuit 32 could be composed of a plurality of separate circuits and discrete circuit elements. In some embodiments, processing circuit 32 will essentially comprise solid state electronic components such as a microprocessor (e.g. microcontroller). Processing circuit 32 may be mounted on a single board in a single location or may be spread throughout multiple locations which cooperate to act as processing circuit 32. In some embodiments, processing circuit 32 may be located in a single location and/or all the components of processing circuit 32 will be closely connected.

Components shown as part of a single processing circuit 32 in the figures may be parts of separate processing circuits in various embodiments covered by the claims unless limited by the claim to a single processing circuit (e.g. location circuit 24 may be part of a separate assembly having a separate microprocessor that interfaces with processing circuit 32 through data port 40).

Hand-held device 10 may also include a network transceiver 44. Transceiver 44 may operate using one or more of a LAN standard, a WLAN standard, a Bluetooth standard, a Wi-Fi standard, an Ethernet standard, and/or some other standard. Network transceiver 44 may be a wireless transceiver such as a Bluetooth transceiver and/or a wireless Ethernet transceiver. Wireless transceiver 44 may operate using an IEEE 802.11 standard. Hand-held device 10 may also include an external device connector 40 (such as a serial data port) for transferring data. External device connector 40 may also serve as the connector 54 to an external power supply. Hand-held device may contain more than one of each of transceiver 44 and external device connector 40. For example, network transceiver 44 may include both a Bluetooth and an IEEE 802.11 transceiver.

Network transceiver 44 may be arranged to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of wireless network systems offering data communication services may include the Institute of Electrical and Electronics Engineers (IEEE) 802.xx series of protocols, such as the IEEE 802.11a/b/g/n series of standard protocols and variants (sometimes referred to as “WiFi”), the IEEE 802.16 series of standard protocols and variants (sometimes referred to as “WiMAX”), the IEEE 802.20 series of standard protocols and variants, and so forth.

Hand-held device 10 may be capable of operating as a mobile phone. The mobile phone may use transceiver 44 and/or may use a cellular transceiver 36. Cellular transceiver 36 may be configured to operate as an analog transceiver, a digital transceiver (e.g. a GSM transceiver, a TDMA transceiver, a CDMA transceiver), or some other type of transceiver. Cellular transceiver 36 may be configured to transfer data (such as image files) and may be used to access the Internet 42 in addition to allowing voice communication. Cellular transceiver 36 may be configured to use one or more of an EV-technology (e.g. EV-DO, EV-DV, etc.), an EDGE technology, a WCDMA technology, and/or some other technology.

Transceiver 44 may be arranged to perform data communications in accordance with different types of shorter range wireless systems, such as a wireless personal area network (PAN) system. One example of a wireless PAN system offering data communication services includes a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), etc.—as well as one or more Bluetooth Profiles, etc. Other examples may include systems using an infrared technique.

Cellular transceiver 36 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth.

In addition to voice communications functionality, the cellular transceiver 36 may be arranged to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth.

Hand-held device 10 may include one or more user input devices 31 (e.g. button, switch, touch screen, keyboard, keypad, voice command circuit, etc.) for registering commands from a user on device 10. Some or all of user input devices 31 may interface with a switch control circuit (not shown) configured to interpret which switches have been actuated. User input device 31 may include an alphanumeric keyboard. The keyboard may comprise, for example, a QWERTY key layout and an integrated number dial pad. A keyboard integrated into a hand-held device would typically be a thumb keyboard. User input device 31 may also include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. Any of user input devices 31 may be concealable behind a body (e.g. a sliding body, a flip-out body, etc.) such that they are hidden when the body is in a first position and visible when the body is in the second position.

Hand-held device 10 may include one or more location determining circuits 24 (e.g. a GPS circuit and/or a cell-based location determining circuit) configured to determine the location of device 10. Device 10 may be configured to receive inputs from more than one location determining circuit 24. These inputs can be compared such that both are used, one (e.g. a cell-based system) can be used primarily when the other (e.g. GPS) is unable to provide reliable location information, or can have some other functional relationship.

Device 10 may use one or more different location determining techniques to derive the location of the device 10 based on the data from location determining circuit 24.

For example, device 10 may use one or more of Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more position determination modes including, for example, a standalone mode, a mobile station (MS) assisted mode, and/or a MS-based mode. In a standalone mode, such as a standalone GPS mode, the mobile computing device 100 may be arranged to autonomously determine its position without network interaction or support. When operating in an MS-assisted mode or an MS-based mode, however, device 10 may be arranged communicate over a radio access network (e.g., UMTS radio access network) with a position determination entity (PDE) such as a location proxy server (LPS) and/or a mobile positioning center (MPC).

In an MS-assisted mode, such as an MS-assisted AGPS mode, the PDE may be arranged to determine the position of the mobile computing device. In an MS-based mode, such as an MS-based AGPS mode, device 10 may be arranged to determine its position with only limited periodic assistance from the PDE. In various implementations, device 10 and the PDE may be arranged to communicate according a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting device 10, the PDE may handle various processing operations and also may provide information to aid position determination. Examples of assisting information may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, and so forth.

In various implementations, the assisting information provided by the PDE may improve the speed of satellite acquisition and the probability of a position fix by concentrating the search for a GPS signal and/or may improve the accuracy of position determination. Each position fix or series of position fixes may be available at device 10 and/or at the PDE depending on the position determination mode. In some cases, data calls may be made and assisting information may be sent to device 10 from the PDE for every position fix. In other cases, data calls may be made and assistance information may be sent periodically and/or as needed.

Hand-held device 10 may include one or more audio circuits 20 (e.g. speakers, microphone, etc.) for providing or receiving audio information to or from a user. In one example, hand-held device 10 includes a first speaker 20 designed for regular phone operation. Hand-held device 10 may also include a second speaker 20 for louder applications such as speaker phone operation, music or other audio playback (e.g. an mp3 player application), etc. Hand-held device 10 may also include one or more audio ports 20 (e.g. a headphone connector) for output to an external speaker and/or input from an external microphone. Audio circuit 20 may be under the control of one or more audio drivers 22 which may include D/A converters and/or an amplifier.

Hand-held device 10 may include a camera 12 for taking pictures using device 10. Camera 12 may include a CCD sensor, a CMOS sensor, or some other type of image sensor capable of obtaining an image (particularly, images sensors capable of obtaining an image formed as an array of pixels). The image sensor may have a resolution of at least about 65,000 pixels or at least about 1 megapixel. In some embodiments, the image sensor may have a resolution of at least about 4 megapixels. Camera 12 may also include read-out electronics for reading data from the image sensor. Image processing circuit 16 may be coupled to the camera 12 for processing an image obtained by the camera. This image processing may include format conversion (e.g. RGB to YCbCr), white balancing, tone correction, edge correction, red-eye reduction, compression, CFA interpolation, etc. Image processing circuit 16 may be dedicated hardware that has been optimized for performing image processing.

Hand-held device 10 may include a display 14 for displaying information to a user. Display 14 could be one or more of an LCD display (e.g. a touch-sensitive color thin-film transistor (TFT) LCD screen), an electroluminescent display, a carbon-nanotube-based display, a plasma display, an organic light emitting diode (OLED) display, and some other type of display. Display 14 may be a touch screen display such that a user may input commands by approaching (e.g. touching) display 14 (including touch screens that require a specialized device to input information). Display 14 may be a color display (e.g., 16 or more bit color display) or may be a non-color (e.g. monotone) display. Display 14 may be controlled by a display driver 18 that is under the control of a microprocessor 26. In some embodiments, display 14 may be used with a stylus. Display 14 may be used as an input to a handwriting recognizer application.

Hand-held device 10 may include a dedicated memory 34 fixed to device 10. Memory 34 may be implemented using any machine-readable or computer-readable media capable of storing data such as erasable or non-erasable memory, writeable or re-writeable memory, and so forth. Dedicated memory 34 may be a non-volatile memory, may be a volatile memory, or may include both volatile and non-volatile memories. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information. In one embodiment, fixed memory 34 is a non-volatile memory.

Although the memory 34 is shown as being separate from and external to processing circuit 32 some portion or the entire memory 34 may be included on the same integrated circuit as processing circuit 32 (e.g. the same integrated circuit as microprocessor 26).

Hand-held device 10 may include a removable memory port 38 configured to receive a removable memory medium, and/or other components. Removable memory port 38 may also serve as an external device connector 40. For example, removable memory port may be an SDIO card slot which can be used to receive memory cards, receive cards input and/or output data, and combined cards having both memory and input/output functions.

Memory 34 and/or memory 38 may be arranged to store one or more software programs to be executed by processing circuit 32.

Dedicated memory 34 and removable memory 38 may be connected to and/or under the control of a common memory controller 28 such as a non-volatile memory controller. Memory controller 28 may be configured to control reading of data to and writing of data from dedicated memory 34 and/or removable memory 38.

Handheld device 10 may be configured to connect to one or more servers 46,48 via a network 42 (such as the Internet) using one or more of network transceiver 44, cellular transceiver 36, and external device connector 40.

Hand-held device 10 may also include a power supply circuit 52 configured to regulate power supply in hand-held device 10. Power supply circuit 52 may be configured to do one or more of control charging of battery 56, to communicate the amount of power remaining in battery 56, determine and/or communicate whether an external power supply is connected, switch between the external power supply and the battery, etc. Battery 56 may be a rechargeable battery and may be removable or may be fixed to device 10. Battery 56 may be formed from any number of types of batteries including silver-based batteries (e.g. silver-zinc, magnesium-silver-chloride, etc.), a lithium-based battery (e.g. lithium-ion, lithium-polymer, etc.), a nickel-based battery (nickel-cadmium, nickel-metal-hydride, etc.), zinc-based batteries (e.g. silver-zinc, carbon-zinc, etc.), etc. External power supply connector 54 may be configured to be connected to a direct current source, an alternating current source, or both DC and AC sources.

Device 10 may have an optical viewfinder (not shown), may use display 14 as a digital viewfinder, may include some other type of view finder, may include multiple types of view finders, or may not include a view finder.

Device 10 may be configured to connect to the Internet 42, which may be a direct connection (e.g. using cellular transceiver 36, external device connector 40, or network transceiver 44) or may be an indirect connection (e.g. routed through external device 50). Device 10 may receive information from and/or provide information to the Internet. Device 10 may include a web browser configured to display information received from the Internet (including information which may be optimized by the browser for display on portable device 10). Device 10 may connect to one or more remote servers 46,48 using the Internet. Device 10 could also connect to another personal electronic device 50 by way of the Internet.

Device 10 may comprise an antenna system (not illustrated) for transmitting and/or receiving electrical signals. Each of the transceivers 36,44 and/or location circuit 24 may include individual antennas or may include a common antenna system. The antenna system may include or be implemented as one or more internal antennas and/or external antennas.

Portable device 10 may comprise a subscriber identity module (SIM) coupled to processing circuit 32. The SIM may comprise, for example, a removable or non-removable smart card arranged to encrypt voice and data transmissions and to store user-specific data for allowing a voice or data communications network to identify and authenticate the user. The SIM may store data such as personal settings specific to the user.

Referring back to FIG. 2, device 10 and/or processing circuit 32 may be configured to run any number of different types of applications. Examples of application programs may include, for example, a phone application 130 (e.g. a telephone application, a voicemail application, etc.), a messaging application 102 (e.g. an e-mail application, an instant message (IM) application, a short message service (SMS) application, a multimedia message service (MMS) application), a web browser application 128, a personal setting application 110 (e.g. a personal information manager (PIM) application), a contact management application 118, a calendar application 116 (e.g. a calendar application, a scheduling application, etc.), a task management application 122, a document application (e.g. a word processing application, a spreadsheet application, a slide application, a document viewer application, a database application, etc.), a location application 114 (e.g. a positioning application, a navigation application, etc.), an image application 112 (e.g. a camera application such as a digital camera application and/or a video camera application, an image management application, etc.) including media player applications (e.g. a video player application, an audio player application, a multimedia player application, etc.), a gaming application, a handwriting recognition application, and so forth. The application software may provide a graphical user interface (GUI) to communicate information between the portable device 10 and a user.

Device 10 may include a location application 114. Location application 114 may be configured to calculate the current position (e.g. the rough current position) of device 10 based on data received from one or more location circuits 24. Location application 114 may be provided with map information such that it can translate coordinate positions into map positions (and vice versa). Location application 114 may be configured to provide navigational information to a user such as turn by turn directions.

Device 10 may include personal organizer applications such as a calendar application 116, a contacts application 118, and a task application (not illustrated). Calendar application 116 may allow a user to schedule events, set alarms for events, and store a wide variety of information for events (e.g. name of the event, location of the event, other attendees of the event, etc.). Contacts application 118 may allow a user to save contact information for a contact such as phone number information (which may be shared with a phone application 130), address information, group information (e.g. which user created group or groups the contact belongs to), and other information about the contact. The task application allows a user to keep track of pending and/or completed tasks.

Device 10 may include an internal clock application 124 that keeps track of time information (such as current time of day and/or date), time zone information, daylight savings time information, etc. Clock application 124 may be a program running based on data from an internal clock of microprocessor 26, data from a separate clock/timing circuit, or data from some other circuit.

Device 10 may also include one or more network connection protocol applications 126 that allow a user to transfer data over one or more networks. Network application 126 may be configured to allow device 10 to access a remote device such as server 46,48.

Device 10 may include an Internet browser application 128 that allows a user to browse the internet. The Internet browser application may be configured to alter the data received from Internet sites so that the data can be easily viewed on portable device 10.

Device 10 may include a phone application 130 configured to allow a user to make phone calls. Phone application 130 may use contact information from contact application 118 to place phone calls.

Device 10 may also include one or more messaging applications 102 that allow a user to send and/or receive messages such as text messages, multi-media messages, e-mails, etc. E-mail messages may come from a server which may use a Push technology and/or may use a pull technology (e.g. POP3, IMAP, etc.).

Any of the information discussed above for any of the applications (e.g. applications 102-128) may be added to or otherwise associated with an image file.

Referring to FIGS. 1 and 7A-7F, a hand-held portable computing device 600 (e.g. smartphone) includes a number of user input devices 31. The user input devices include a send button 604 configured to select options appearing on display 603 and/or send messages, a 5-way navigator 605 configured to navigate through options appearing on display 603, a power/end button 606 configured to select options appearing on display 603 and to turn on display 603, a phone button 607 usable to access a phone application screen, a calendar button 608 usable to access a calendar application screen, a messaging button 609 usable to access a messaging application screen, an applications button 610 usable to access a screen showing available applications, a thumb keyboard 611 (which includes a phone dial pad 612 usable to dial during a phone application), a volume button 619 usable to adjust the volume of audio output of device 600, a customizeable button 620 which a user may customize to perform various functions, a ringer switch 622 usable to switch the smartphone from one mode to another mode (such as switching from a normal ringer mode to a meeting ringer mode), and a touch screen display 603 usable to select control options displayed on display 603. Touch screen display 603 is also a color LCD display 14 having a TFT matrix.

Smartphone 600 also includes audio circuits 20. The audio circuits 20 include phone speaker 602 usable to listen to information in a normal phone mode, external speaker 616 louder than the phone speaker (e.g. for listening to music, for a speakerphone mode, etc.), headset jack 623 to which a user can attach an external headset which may include a speaker and/or a microphone, and microphone 625 which can be used to pick up audio information such as the user's end of a conversation during a phone call.

Smartphone 600 also includes a status indicator 601 that can be used to indicate the status of Smartphone 600 (such as messages pending, charging, low battery, etc.), a stylus slot 613 for receiving a stylus such as a stylus usable to input data on touch screen display 603, a digital camera 615 (see camera 12) usable to capture images, a mirror 614 positioned proximate camera 615 such that a user may view themselves in mirror 614 when taking a picture of themselves using camera 615, a removable battery 618 (see battery 56), and a connector 624 (see external data connector 40 and external power supply 54) which can be used to connect device 600 to either (or both) an external power supply such as a wall outlet or battery charger or an external device such as a personal computer, a gps unit, a display unit, or some other external device.

Smartphone 600 also includes an expansion slot 621 (see removable memory 38) which may be used to receive a memory card and/or a device which communicates data through slot 621, and a SIM card slot 617, located behind battery 618, configured to receive a SIM card or other card that allows the user to access a cellular network.

In various embodiments device 10 and device 600 may include a housing 640. Housing 640 could be any size, shape, and dimension. In some embodiments, housing 640 has a width 652 (shorter dimension) of no more than about 200 mm or no more than about 100 mm. According to some of these embodiments, housing 640 has a width 652 of no more than about 85 mm or no more than about 65 mm. According to some embodiments, housing 640 has a width 652 of at least about 30 mm or at least about 50 mm. According to some of these embodiments, housing 640 has a width 652 of at least about 55 mm.

In some embodiments, housing 640 has a length 654 (longer dimension) of no more than about 200 mm or no more than about 150 mm. According to some of these embodiments, housing 640 has a length 654 of no more than about 135 mm or no more than about 125 mm. According to some embodiments, housing 640 has a length 654 of at least about 70 mm or at least about 100 mm. According to some of these embodiments, housing 640 has a length 654 of at least about 110 mm.

In some embodiments, housing 640 has a thickness 650 (smallest dimension) of no more than about 150 mm or no more than about 50 mm. According to some of these embodiments, housing 640 has a thickness 650 of no more than about 30 mm or no more than about 25 mm. According to some embodiments, housing 640 has a thickness 650 of at least about 10 mm or at least about 15 mm. According to some of these embodiments, housing 640 has a thickness 650 of at least about 50 mm.

While described with regards to a hand-held device, many embodiments are usable with portable devices which are not handheld and/or with non-portable devices/systems.

The various single applications discussed above may be performed by multiple applications where more than one application performs all of the functions discussed for the application or where one application only performs some of the functions discussed for the application. For example, the image application 112 may be divided into an image capturing application and a separate image viewing application. Also, more than one application may be included on device 10 that is capable of displaying images as described for image application 112.

Further, while shown as separate applications above, many of the above listed applications can be combined into single applications that perform all or some of the functions listed for more than one of the applications discussed above.

While some components in FIG. 1 were discussed as being singular and others were discussed as being plural, the invention is not limited to devices having these same numbers of each type of component. Embodiments are conceived where each combination of plural and singular components exist.

While much of the discussion was directed at still photographs, this discussion is equally applicable to other types of media such as movies and sound recordings. For example, device 10 can be used to add additional data (metadata) to sound recording files, and can use the filters to sort through sound recording files. In some embodiments, the filters may cause multiple types of media files to be grouped based on the filters (such as all movies, sound recordings, and photographs taken at a selected event). As another example, instead of identifying objects 212 using image recognition, people, places, events, or other things associated with a movie or other sound recording could be identified 212 using sound (e.g. voice) pattern recognition.

Additionally, much of the disclosure need not be limited to media files. As one example, metadata similar to the metadata applied to media files created by the device 10 can also be applied to other data files. For instance, location and/or time information can be applied to a note file. As a second example, any file having time information may be accessed from a calendar application. Thus, selecting a command (e.g. icon) associated with an event in a calendar application may allow a user to access any number of files created or received around the time of the event, such as notes, drawings, photographs, games, songs, movies, etc.

An image that is essentially the same image will be considered the same image for purpose of the claim unless the claim recites that one image is identical to a previously recited image. An “altered image” for purposes of the claim is an image that has been altered beyond the point of being essentially the same image as before the alteration.

While discussion is made with respect to organizing image files based on an input from a calendar application, it is within the scope of the patent that image files may be organized based on inputs from each (and combinations of each) of the applications shown in FIG. 2.

In some embodiments, the various components shown in FIG. 1 may be combined in a single component. For example, in some embodiments, removable memory 38 may also be an external device connector 40 (such as an SDIO card slot which can be used to receive memory cards, input and/or output data, and combined devices having both memory and input/output functions). As another example, in some embodiments, a single connector could serve as both an external device connector 40 and as a connection to an external power supply 54.

Also, in some embodiments, the function of various claim components shown in FIG. 1 may be performed by a combination of distinct electrical components. For instance, a location circuit 24 may have a separate microprocessor that works in combination with the main microprocessor 26 of the system to perform the functions of the processing circuit 32. As another example, image processing circuit 16 may make use of the electronics of camera 12 to perform image processing, while also having other, discrete electronic components.

A number of references have been made to transmitters, receivers, and/or transceivers. Each reference to a transmitter or receiver is equally applicable to a transceiver. Reference in the claim to a transmitter or receiver is also a reference to a transceiver unless it is explicitly stated that the claim is referencing an independent transmitter or receiver. Reference to functions achieved by a transceiver above could also be accomplished by combining an independent transmitter and receiver. Reference in the claims to a transceiver can also be a reference to a transmitter-receiver combination unless reference is made in the claim to a unitary transceiver.

What is claimed is:

1. A mobile phone, comprising:
an audio circuit configured to receive and provide audio information;
a network transceiver configured to transfer data between the mobile phone and a network access point;
a global positioning circuit configured to provide information relating to a location of the mobile phone;
a processing circuit configured to
place a phone call, the phone call using the audio circuit to transfer voice data,
transfer voice data during the phone call to one or more of a multiplicity of network access points using the network transceiver, and
use data from the global positioning circuit to provide location information relating to the phone call to a remote device; and
a housing configured to contain the audio circuit, the network transceiver, and the processing circuit.

2. The mobile phone of claim 1, wherein the housing has a volume of up to about 2550 cubic centimeters.

3. The mobile phone of claim 1, wherein the processing circuit is configured to provide location information for a limited set of calls.

4. The mobile phone of claim 3, wherein the processing circuit is configured to automatically provide location information during emergency calls.

5. The mobile phone of claim 1, wherein the location information provided by the processing circuit is sufficient to accurately identify a location of the mobile phone to within about 10 feet.

6. The mobile phone of claim 1, wherein the location information provided by the processing circuit comprises information relating to a location of the mobile phone based on data from the global positioning circuit and data from an additional source.

7. The mobile phone of claim 1, wherein the processing circuit is configured to determine the location of the mobile phone, and wherein the location information provided by the processing circuit includes the determined location.

8. The mobile phone of claim 1, wherein the mobile phone does not include a cellular transceiver.

9. The mobile phone of claim 1, wherein the processing circuit is configured to transfer voice data during the phone call to one or more of a multiplicity of network access points using an Internet Protocol.

10. A system using the mobile phone of claim 1, comprising:
the mobile phone;
the remote device, the remote device being a first remote device, the first remote device configured to receive location information from the mobile phone, process the location information, and provide location information to a second remote device in a format identifiable by the second remote device, the second remote device being remote from the mobile phone and the first remote device.

11. The system of claim 10, wherein the location information transferred from the mobile phone to the first remote device is not in a format identifiable by the second remote device.

12. The system of claim 10, wherein the second remote device is configured to obtain location information relating to the location of the mobile phone from sources other than the mobile phone.

13. The system of claim 12, wherein the second remote device is configured to obtain location information relating to the location of the mobile phone from sources other than the mobile phone based on one or more access points used to place the phone call.

14. The system of claim 12, wherein the first remote device is configured to obtain location information relating to the location of the mobile phone from sources other than the mobile phone based on one or more cell towers usable accessible by a cellular transceiver contained within the housing of the mobile phone.

15. The system of claim 10, wherein the second remote device is a part of an emergency contact system.

16. The system of claim 10, wherein the second remote device is a mobile phone.

17. A mobile phone, comprising:
an audio circuit configured to receive and provide audio information;
a network transceiver configured to transfer data between the mobile phone and a network access point;
a processing circuit configured to
place a phone call, the phone call using the audio circuit to transfer voice data,
transfer voice data during the phone call to one or more of a multiplicity of network access points using the network transceiver, and
receive data relating to a location of the mobile phone, and
use the data relating to the location of the mobile phone to provide location information relating to the phone call to a remote device; and
a housing configured to contain the audio circuit, the network transceiver, and the processing circuit.

18. A mobile phone, comprising an audio circuit; and a processing circuit having a voice over Internet Protocol mode that allows voice communication using the audio circuit, the voice over Internet Protocol mode allowing a user to roam, the processing circuit configured to provide location information relating to a location of the mobile phone to a remote device during a voice session established in the voice over Internet Protocol mode.

19. The mobile phone of claim 18, wherein the processing circuit is configured to provide location information for a limited set of calls, and is configured to automatically provide location information during emergency calls.

20. The mobile phone of claim 18, wherein the location information provided by the processing circuit is sufficient to accurately identify a location of the mobile phone to within about 10 feet.

21. The mobile phone of claim 18, wherein the location information provided by the processing circuit comprises information relating to a location of the mobile phone based on data from a global positioning circuit of the mobile phone and data from an additional source.

22. The mobile phone of claim 18, wherein the processing circuit is configured to determine the location of the mobile phone, and wherein the location information provided by the processing circuit includes the determined location.

23. The mobile phone of claim 18, wherein the mobile phone does not include a cellular transceiver.

24. A method for identifying the location of a phone communication using a voice over Internet protocol, comprising:
receiving a phone call from the mobile phone using a voice over Internet protocol; and
receiving location information from the mobile phone representative of the location of the mobile phone.

25. The method of claim 24, further comprising identifying the location of the mobile phone using the location information received from the mobile phone, and sending location information based on the identified location.

26. The method of claim 24, wherein sending location information comprises sending location information to an emergency call service.

27. The method of claim 24, wherein identifying the location of the mobile phone comprises identifying the location of the mobile phone using information not received from the mobile phone.

28. The method of claim 24, wherein identifying the location of the mobile phone comprises identifying the location of the mobile phone primarily using information received from the mobile phone.

29. A method for placing an emergency call while a phone is in a voice over Internet protocol mode, comprising:
providing phone options in a voice over Internet protocol mode;
identifying a phone number to be dialed in the voice over Internet protocol mode as an emergency service phone number; and
dialing the phone number using a cellular transceiver based on the determination.

30. The method of claim 29, further comprising identifying the location of the mobile phone in response to dialing the phone Number.
